(19) United States
(12) Patent Application Publication
(10) Pub. No.: US 2015/0086967 A1
(43) Pub. Date: Mar. 26, 2015

(54) Method and Apparatus for Providing Predetermined Slice Thicknesses of Deli Products

(71) Applicant: Thomas Joseph Majcher, Orchard Lake, MI (US)

(72) Inventor: Thomas Joseph Majcher, Orchard Lake, MI (US)

(21) Appl. No.: 14/034,311

(22) Filed: Sep. 23, 2013

(51) Int. Cl. G09B 25/00

(52) U.S. Cl. CPC G09B 25/00
USPC 434/428

(57) ABSTRACT

A unique and carefully devised method and apparatus for defining, visualizing, and reproducing predetermined slice thicknesses of deli products makes it possible for deli personnel to fulfill a customer's request without iterative feedback from the customer. This is beneficial to both the customer and deli personnel—eliminating ambiguity, aggravation, wasted product, wasted time, and wasted energy. This is accomplished by first defining ambiguous terms such as “thin”, “medium”, and “thick”, in terms of quantifiable dimensions. Samples of these predetermined thickness are then available to be viewed by the customer. Finally, slices are reproduced in accordance with the samples by correlating the thickness adjustment setting on a particular deli slicer necessary to produce a particular slice thickness.

### BACKGROUND OF THE INVENTION

Attempting to specify the thickness of a slice at a deli counter is a daunting task. Unfortunately, the best method available seems to be relaying a desired thickness to deli personnel by way of showing a distance between the thumb and index finger, giving a vague description such as “medium”, and then relying upon one or more iterations of cut slices for further evaluation. This method holds up the line, is inaccurate, results in wasted product, wasted time, wasted energy, and frustration on the part of the customer as well as deli personnel. The customer will typically receive a thickness “close enough” at best to what was desired. Surprisingly, a combination of three distinct elements must be addressed to arrive at a practical and useful solution to this problem, which shall be addressed in the proceeding specification.

The first element which shall be addressed to derive a system to provide predetermined thicknesses of deli products is the establishment of a naming convention and corresponding quantifiable definitions of thickness. Non-quantified terms such as “thin”, “medium”, and “thick”, must be quantified to a corresponding dimensional thickness. Such a convention has been established in the chart shown in FIG. 1. This convention bears numerous unique benefits. Not only have increments been carefully chosen to correspond to practical increases in thickness, but also corresponding values of customary and metric units allow for ease of incrementing units in both systems. Inches increment in units of 0.02 and corresponding values in millimeters in increments of 0.5 within an acceptable accuracy of 0.1 mm. Dimensions are also shown in fractional inch designations in 1/16 inch increments within an accuracy of 0.01 inches. By assigning numerical values in increments of 1 from 0 to 12 for thickness descriptions, this convention further has the benefit of correlating a number description readily to a dimension, i.e., #6 (Medium)×0.02=0.12 inches or 6×0.5=3 mm.

Though a customer may know the thickness desired in terms of a dimension, the deli slicer industry does not commonly allow for readily reproducing a slice to such a thickness. This issue will be addressed further below in the specification. In either case, most customers will want to physically see the thickness that the slice will be in a tangible form. Therefore, a means of providing such a sample to the customer must be met. The sample shall be made in accordance with the convention previously established to readily identify the thickness desired. To this end, a sample display shall be utilized, made of a sufficiently rigid material such as plastic, bearing the likeness of FIG. 2, showing a front perspective view thereof. The sample, when placed upon a deli counter, allows the slice thicknesses to be clearly seen from all sides. FIG. 4 shows the slice description chart affixed to the front of the display, with the respective descriptions aligned with their corresponding sample slices.

The spacers between the slices, when extended beyond the back edges of the sample slices as shown in the rear perspective view of FIG. 3, serve as a gage by which deli personnel may compare an actual slice to the sample thicknesses by sliding the slice between the top surface of the spacer below the sample slice and the bottom surface of the spacer above the sample slice. The plastic film commonly used to wrap cut slices, being of negligible thickness, would be used to avoid direct contact between the deli products and the sample.

Alternatively, sample slices may be arranged in a fashion similar to pages in a book, while staggering the layers, as shown in FIG. 7, and could be made of a flexible material such as rubber. However, the spaced samples of FIGS. 2 thru 4 provide maximum visibility to the customer as well as the ability to gage actual slices. Furthermore, customers would be more apt to physically handle the sample of FIG. 7, both out of necessity to gain a good view, as well as out of convenience due to the book-like composition. A one dimensional or two dimensional representation of thickness, i.e., simply printing a dimensional representation on the description chart itself, as shown in FIG. 5, may be sufficient. However, the 3-dimensional sample of FIGS. 2 thru 4 provides the most realistic and intuitive representation of the actual resulting slice to the customer, and is therefore preferred.

Having established quantifiable descriptions and corresponding tangible representations to the customer, it is now necessary to establish a convenient and reliable system of reproducing slices of these thicknesses. The method devised takes into account variation in slicer equipment and the need to provide maximum convenience to deli personnel. Though perhaps not obvious, a lack of any preceding element would largely negate the usefulness of providing the previously established convention and samples. Therefore, a convenient and versatile method and apparatus shall be presented to correlate the setting on any given deli slicer to the herein previously established convention. A knob will be herein referred to as the means by which the deli slicer is adjusted to vary slice thickness, though other mechanisms (such as levers) may be used to accomplish the same function, and the “setting” will refer to the position indicated by markings on and/or surrounding the knob, such as a numerical scale surrounding the knob which aligns with an indicator on the knob. In the case where an adjustment knob may not have markings suitable for establishing its position pursuant to correlating the slicer setting to the description chart, adhesive labels (which may be marked with a suitable identifier) may be affixed to the knob and/or surface area surrounding the knob, such as shown in the form of the small circular dots in FIG. 8, with the large circle illustrating the knob. Such dots would be included with this system and could also be used to draw attention to existing markings if desired.

Deli personnel will correlate a cut slice to a sample thickness (within a practical tolerance). As previously described, the spacers of the display sample may be used as a gage. The setting used on the slicer to deliver the particular thickness shall be recorded alongside the slice description in the column labeled “Setting on Slicer” of the slicer correlation chart of FIG. 6, with the cell in the first row labeled “Slicer ID” being an identifier for the particular slicer used, in the event of different slicers used at the same deli. In cases where the slicer thickness may be adjusted in terms of either inches or millimeters directly, such dimension may be referenced directly from the description on the chart. To facilitate convenience and flexibility, adhesive labels shall be provided for adhering the determined setting at the appropriate cell on the chart. Changes may then be made by adhering one label atop another. Labels are chosen over another method of editing, such as an erasable marker, to prevent smudging and otherwise unintended erasure.

The slicer correlation chart of FIG. 6 shall be placed near the relevant slicer. It should be noted that once adjustment knob rotation is established by deli personnel to achieve a change in thickness of 0.02 inches, slicer settings for the various thicknesses may be established methodically with ease. Upon the request of a customer for a slice thickness “#6”, for example, deli personnel may readily set the slicer to the setting indicated alongside row #6 of the correlation chart. Slices shall be reproduced in this manner to the accuracy and repeatability capability of a given deli slicer. A practical number of rows shall be provided, as shown beneath row #12 of FIG. 6, for adding additional settings which may be useful for particular situations. A short ruler, approximately 2 inches long, may be provided for measuring slices thicker than the samples provided. The display fixture for the chart may also contain one or more features for holding a ruler, labels, and a writing instrument so as to facilitate convenience and organization.

The specification herein described has set forth a comprehensive and reliable method of standardizing, describing, visualizing, and accurately reproducing slices of deli products at predetermined thicknesses. This method, in combination with the apparatus herein specified, shall, to the benefit of the customer and deli personnel, eliminate the trial and error method of slicing deli products to a customer's satisfaction—eliminating ambiguity, aggravation, wasted product, wasted time, and wasted energy.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having thus described the invention, what is desired to be protected by Letters Patent is presented in the subsequently appended claims.

### BRIEF DESCRIPTION OF THE FIGURES

FIG. 1 shows a chart establishing a naming convention with corresponding quantifiable definitions of thickness for deli products.

FIG. 2 shows a front perspective view of a 3-dimensional sample, making predetermined slice thicknesses visible to customers;

FIG. 3 shows a rear perspective view thereof,

FIG. 4 shows a front view thereof, with the sample slices being identified by the naming convention and thickness definitions set forth by the chart of FIG. 1.

FIG. 5 shows a front view of a 2-dimensional sample, making predetermined slice thicknesses visible to customers;

FIG. 6 shows a slicer correlation chart to correlate the predetermined sample slice thicknesses to the setting on the deli slicer necessary to reproduce the particular slice thickness.

FIG. 7 shows a top perspective view of an embodiment serving as a sample of slice thickness to the customer; and

FIG. 8 shows a front view of a depiction of a deli slicer knob, having been marked with labels to identify the settings corresponding to the predetermined slice thicknesses.

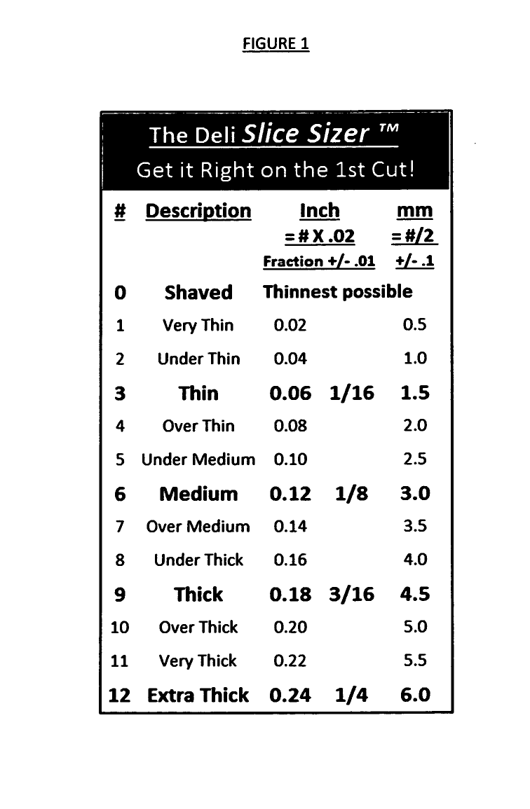

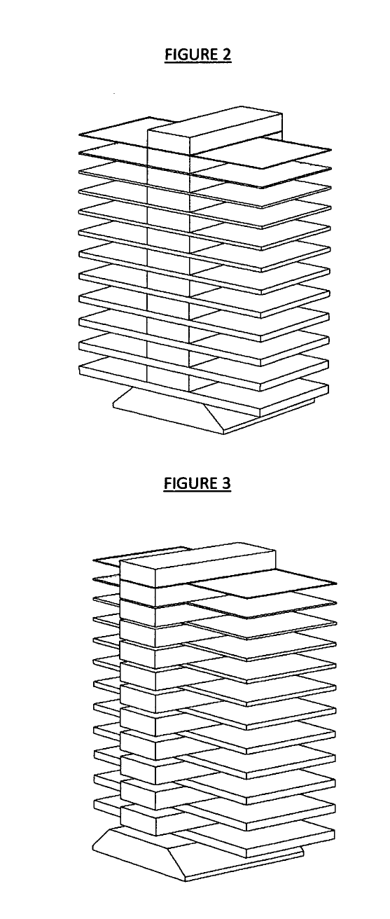

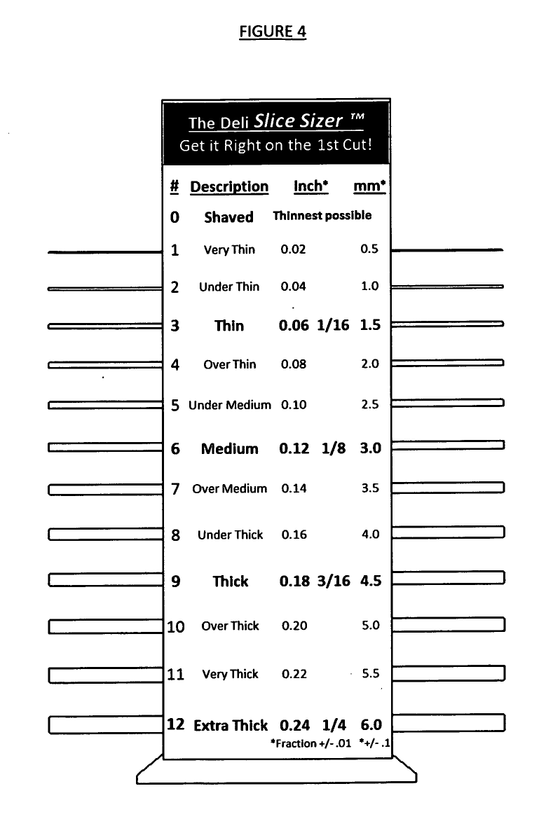

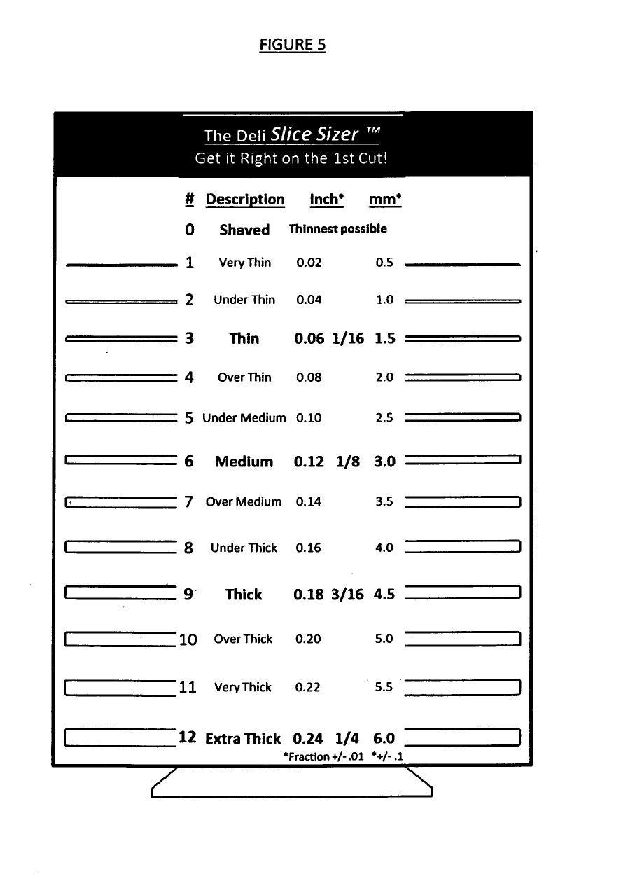

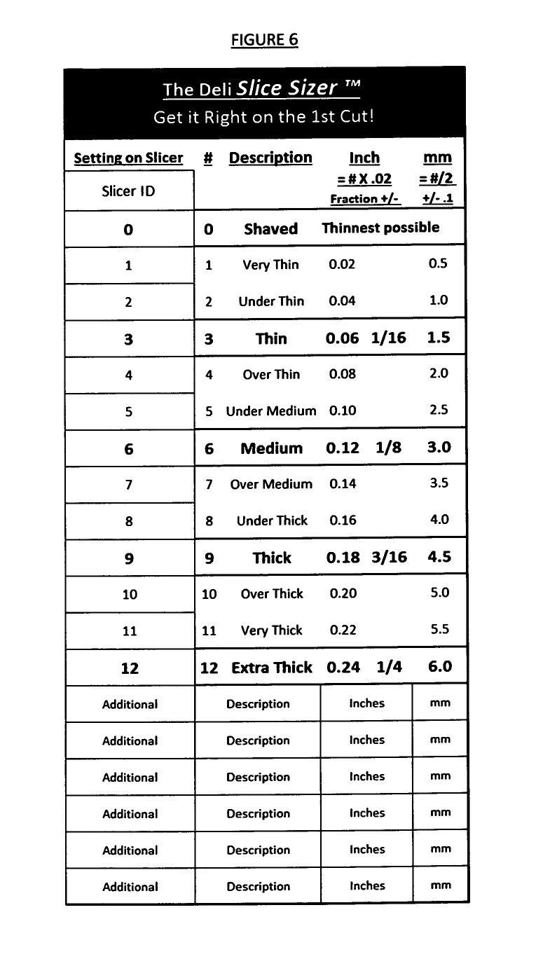

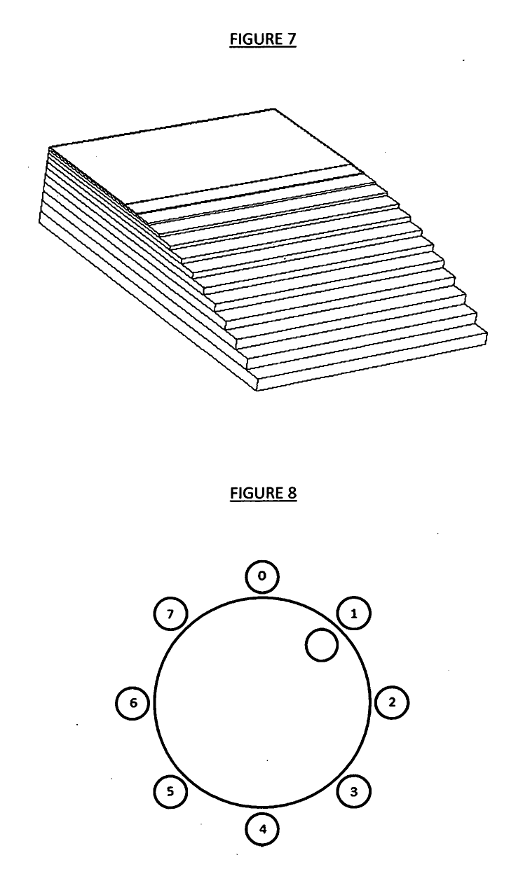

What is claimed is:

1. A system of defining, visualizing, and reproducing predetermined slice thicknesses of deli products, whereby deli personnel may fulfill a customer's request without iterative feedback from said customer, comprising;
a. a definition of each said predetermined slice thickness in terms of at least one value chosen from the following group: a dimensional unit, a description corresponding to a dimensional unit, an identifier corresponding to a dimensional unit, and an identifier corresponding to a predetermined sample;
b. said sample, making said predetermined slice thicknesses visible to said customer; and
c. means of correlating each said predetermined slice thickness to the particular setting on a deli slicer necessary to reproduce said predetermined slice thickness.

2. The system of claim 1, wherein said definitions for said predetermined slice thicknesses are chosen from the following descriptions: shaved, very thin, under thin, thin, over thin, under medium, medium, over medium, under thick, thick, over thick, very thick and extra thick.

3. The system of claim 1, wherein said slice thicknesses are defined in increments of 0.02 inches, being substantially coincident with fractional inch increments of sixteenths of an inch and metric increments of 0.5 mm.

4. The system of claim 1, wherein various said slice thicknesses are identified in increments of 1 from 0 to 12.

5. The system of claim 1, wherein said sample is comprised of visual representations of said predetermined slice thicknesses selected from the group consisting of one-dimensional representations, two-dimensional representations, and three-dimensional representations.

6. The system of claim 1, wherein said means of correlating predetermined slice thicknesses is achieved by writing said setting next to said definition of slice thickness.

7. The system of claim 1, wherein space is provided on said means of correlating predetermined slice thicknesses for writing at least one additional definition of slice thickness and corresponding said slicer setting.

8. The system of claim 1, wherein at least one label is affixed to at least one element chosen from the group consisting of the deli slicer thickness adjustment knob and the surface area surrounding said knob, said surface area being sufficient to indicate movement of said knob relative to said surface area; thereby facilitating a means of correlating the particular setting on a deli slicer necessary to reproduce a particular said predetermined slice thickness.
